(19) United States
(12) Patent Application Publication
(10) Pub. No.: US 2010/0104405 A1
(43) Pub. Date: Apr. 29, 2010

(54) STACKER CRANE

(76) Inventor: Hiroyuki Amada, Yokohama-shi (JP)

Correspondence Address: OSTROLENK FABER GERB & SOFFEN, 1180 AVENUE OF THE AMERICAS, NEW YORK, NY, 100368403, US

(21) Appl. No.: 12/443,214

(22) PCT Filed: Sep. 20, 2007
(86) PCT No.: PCT/JP2007/068264

§ 371 Date: Mar. 27, 2009

(30) Foreign Application Priority Data
Sep. 28, 2006 (JP) 2006-265894

(51) Int. Cl. B65G 1/04

(52) U.S. Cl. 414/281

(57) ABSTRACT

A stacker crane, which transports goods between storage shelves, comprises the storage shelves arranged on a plurality of levels; an elevator portion, traveling on tracks provided along the storage shelves, and which accommodates goods; a set of masts, which move vertically while in contact with the elevator portion; and, a mast support frame, installed avoiding the region of movement of the elevator portion in the range in which the elevator portion and the masts can make contact. By this means, the occurrence of dead space due to interference between the elevator portion and the lower frame can be prevented.

### TECHNICAL FIELD

This invention relates to a stacker crane, and in particular relates to a stacker crane the elevator portion of which moves vertically between a set of masts.

This application claims priority from Japanese Patent Application No. 2006-265894, filed with the Japanese Patent Office on Sep. 28, 2006, the contents of which are incorporated herein by reference.

### BACKGROUND ART

For example, in an automated warehouse in which goods are stored on a plurality of storage shelves arranged in parallel in the vertical and horizontal directions, a stacker crane is used to convey goods. This stacker crane travels on a track provided along the storage shelves for goods, and by using a driving device to raise and lower a cage suspended via an elevator wire, can transfer goods between arbitrary storage shelves.

In an automated warehouse comprising such a stacker crane, improvement of the efficiency of storing goods is regarded as a general technical problem.

For example, in Patent Reference 1, technology is described in which, by installing, on the outside of two masts connected by an upper frame and a lower frame, an elevator portion (elevator frame) which moves vertically along the masts, the elevator portion can move vertically without interfering with the lower frame, and by this means the occurrence of dead space is prevented.

By means of such technology, there is not the dead space which occurs due to interference between the elevator portion and the lower frame, and space can be utilized effectively, so that the efficiency of storage of goods in an automated warehouse can be improved.

Patent Reference 1: Japanese Unexamined Patent Application, First Publication No. 5-17011

However, because in the technology described in Patent Reference 1 the elevator portion must be installed on the outside of the masts, and so the length in the traveling direction of the stacker crane is increased. For this reason, dead space occurs in the direction of travel of the stacker crane. Further, because the elevator portion must be cantilevered, in cases in which the goods are heavy objects, stable conveyance is difficult.

### DISCLOSURE OF THE INVENTION

This invention was devised in light of the above-described problem, and has an object, in a stacker crane in which an elevator portion moves vertically between masts, of preventing the occurrence of dead space arising from interference between the elevator portion and the lower frame.

In order to attain the above object, a stacker crane of this invention travels on a track provided along storage shelves arranged on numerous levels, and by causing an elevator portion which receives goods to move vertically between a set of masts while being in contact with the masts, goods are conveyed between the various storage shelves, and is characterized in comprising a mast support frame, which is installed avoiding the movement region of the elevator portion in the range in which contact between the elevator portion and the masts is possible.

According to this invention having these characteristics, the mast support frame is installed avoiding the region of movement of the elevator portion in the range in which contact between the elevator portion and the masts is possible.

Hence in the range in which contact between the elevator portion and the masts is possible, there is no interference between the elevator portion and the mast support frame.

Further, in this invention, the mast support frame can adopt a configuration comprising a pair of main frames, positioned along the track and at a greater distance apart than the width of the elevator portion, and side frames which connect end portions of the main frames to each other.

Further, in this invention, a configuration can be adopted in which the interval between the main frames is smaller than the width of the goods.

Further, in this invention, a configuration can be adopted in which the masts extend from the mast support frame to near the track laying surface on which the track is laid.

By means of this invention, the mast support frame is installed avoiding the region of movement of the elevator portion in the range in which contact between the elevator portion and the masts is possible, so that there is no interference between the elevator portion and the mast support frame in the range in which contact between the elevator portion and the masts is possible.

Hence in a stacker frame in which an elevator portion moves vertically between masts, the occurrence of dead space due to interference between the elevator portion and the lower frame can be prevented.

### BRIEF DESCRIPTION OF THE DRAWINGS

FIG. 1 is a plane view of an automated warehouse comprising the stacker crane of one aspect of the invention;

FIG. 2 is a side view of an automated warehouse comprising the stacker crane of one aspect of the invention;

FIG. 3 is a perspective view of the stacker crane of one aspect of the invention;

FIG. 4 is a front view of the stacker crane of one aspect of the invention; frame;

FIG. 5 is a plane view showing schematically a lower

FIG. 6 is a perspective view of a cage comprised by the stacker crane of one aspect of the invention; and,

FIG. 7 is a perspective view of a lower frame, seen from below.

### DESCRIPTION OF SYMBOLS

1 WHEEL
1a WHEEL
1b GUIDE ROLLER
2 MOTOR
10 LOWER FRAME
11 WHEEL MOUNTING PORTION
12 MAIN FRAME
13 SIDE FRAME
13a SIDE FRAME
13b SIDE FRAME
20 MAST
20a MAST
20b MAST
30 UPPER FRAME
40 CAGE
41 MAIN FRAME
42 REINFORCING MEMBER
43 SIDE FRAME
44 GUIDE PORTION
44a GUIDE PORTION
44b GUIDE PORTION
46 GUIDE ROLLER
47 GUIDE ROLLER
48 CONNECTION PORTION
50 DRIVING DEVICE
51 ELEVATOR WIRE
51a ELEVATOR WIRE
51b ELEVATOR WIRE
52 DRUM
53 MOTOR
54 DECELERATOR
55 SHEAVE
55a SHEAVE
55b SHEAVE
60 CONTROL DEVICE
61 CABLE
100 TRANSFER DEVICE
431 SIDE FRAME
432 SIDE FRAME
A REGION
B REGION
C STACKER CRANE
CL1 CLEANROOM
R RAIL
R1 RAIL
R2 RAIL
R3 RAIL
S AUTOMATED WAREHOUSE
T STORAGE SHELF
T1 RACK
T2 RACK
X GOODS

### BEST MODE FOR CARRYING OUT THE INVENTION

Below, an embodiment of a stacker crane of this invention is explained, referring to the drawings. In the drawings below, the scale of various members is modified as appropriate in order that the various members be of a size enabling identification.

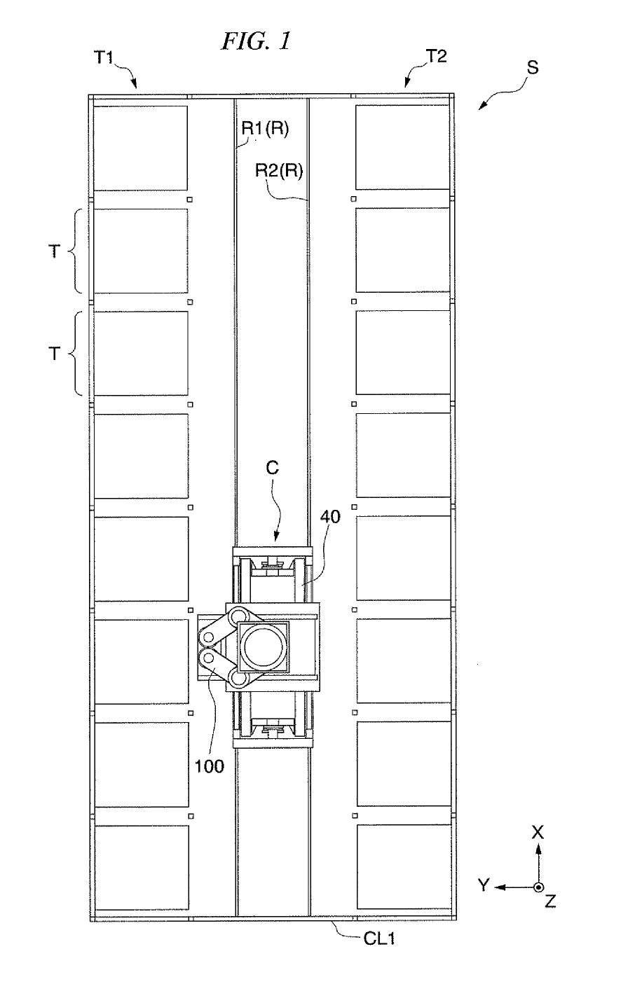

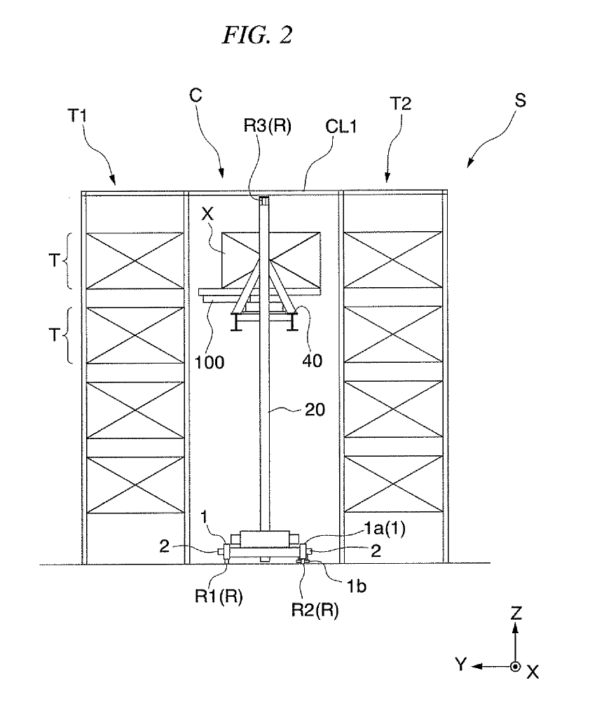

FIG. 1 is a plane view of an automated warehouse S comprising the stacker crane C of this embodiment. FIG. 2 is a side view of the automated warehouse S.

As shown in these figures, the automated warehouse S comprises the stacker crane C, and racks T1, T2 positioned in opposition on either side of rails R, which are the track of the stacker crane C; goods are conveyed to and stored on the racks T1, T2 by the stacker crane C. The automated warehouse S further comprises a stocking conveyor (not shown) to stock goods, and a destocking conveyor (not shown) to destock goods; goods can be transferred between the stocking conveyor and the destocking conveyor by the stacker crane C.

In this embodiment, the goods are cassettes X in which are accommodated a plurality of glass substrates; the racks T1, T2 and stacker crane C are installed within a cleanroom CL1 with a cleanliness level of, for example, 10,000.

The racks T1, T2 comprise a plurality of storage shelves T arranged in the horizontal and vertical directions; cassettes X can be stored on each storage shelf T. That is, the racks T1, T2 comprise storage shelves T arranged on numerous levels. Further, the racks T1, T2 are configured with mutually opposing sides as the entries/exits for cassettes X.

In the following explanations, the horizontal arrangement direction of storage shelves T is the X direction, the horizontal direction perpendicular to the X direction is the Y direction, and the vertical direction perpendicular to the X-Y plane is the Z direction.

The rails R extend in the X direction, that is, are laid along the racks T1 and T2, and comprise rails R1 and R2 laid in parallel and at a prescribed interval on the floor of the cleanroom CL1, and a rail R3 laid on the ceiling of the cleanroom CL1.

The stacker crane C is supported from below by the rails R1 and R2, and comprises four wheels 1 which can rotate on the rails R1 and R2. Motors 2 are connected to each of the wheels 1, and the wheels 1 are driven in rotation by the motors 2 to cause the stacker crane C to travel on the rails R1, R2. Among the wheels 1, on the wheels 1a which rotate on the rail R2, are installed guide rollers 1b which are in contact with both side faces of the rail R2, and by means of the guide rollers 1b, the wheels 1a are guided on the rail R2.

The stacker crane C further comprises a cage 40 (elevator portion) which moves vertically; by means of a transfer device 100 (for example, a forklift device) installed on the cage 40, cassettes X are passed between the cage 40 and storage shelves T, between the cage 40 and the stocking conveyor, and between the cage 40 and the destocking conveyor.

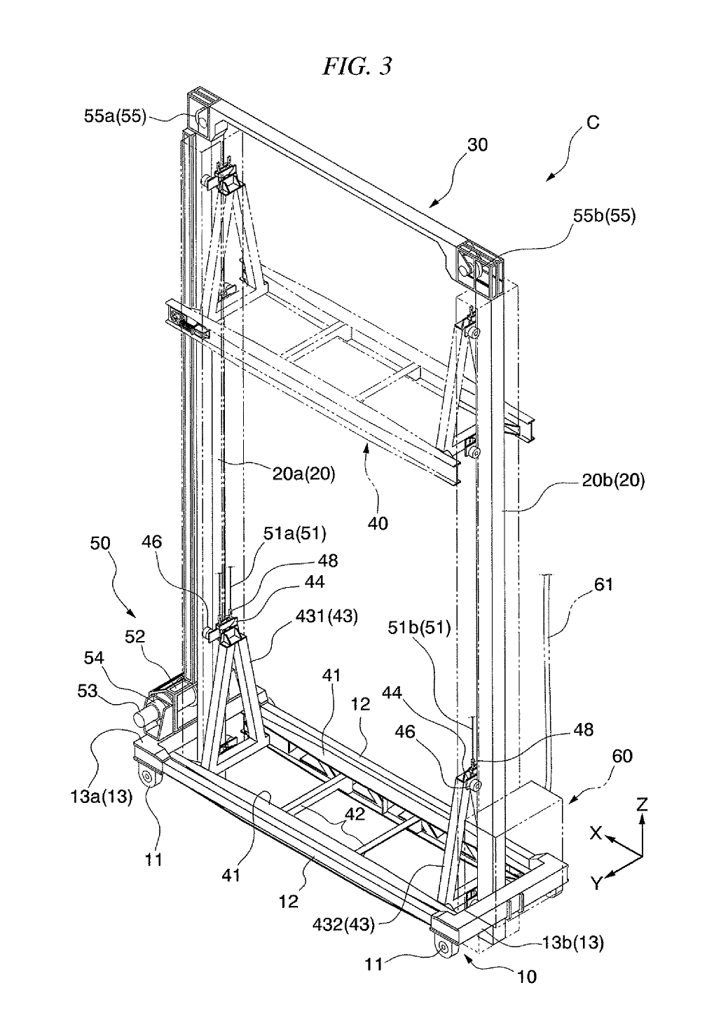

Next, details of the stacker crane C are explained, referring to FIG. 3 through FIG. 7.

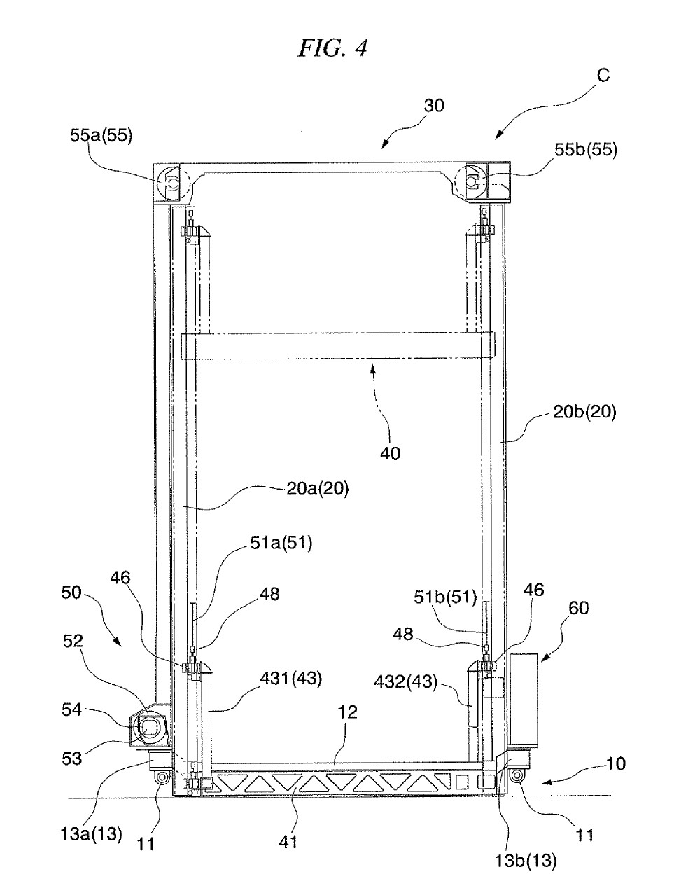

FIG. 3 is a perspective view of the stacker crane C. FIG. 4 is a front view of the stacker crane C. In FIG. 3 and FIG. 4, in order to improve the intelligibility of the drawings, the wheels 1, motors 2, guide rollers 1b, and transfer device 100 comprised by the stacker crane C are omitted.

As shown in these figures, the stacker crane C comprises a lower frame 10 (mast support frame), masts 20, an upper frame 30, a cage 40, a driving device 50, and a control device 60.

The lower frame 10 is a foundation having wheel mounting portions 11, on which the above-described wheels 1 are rotatably installed.

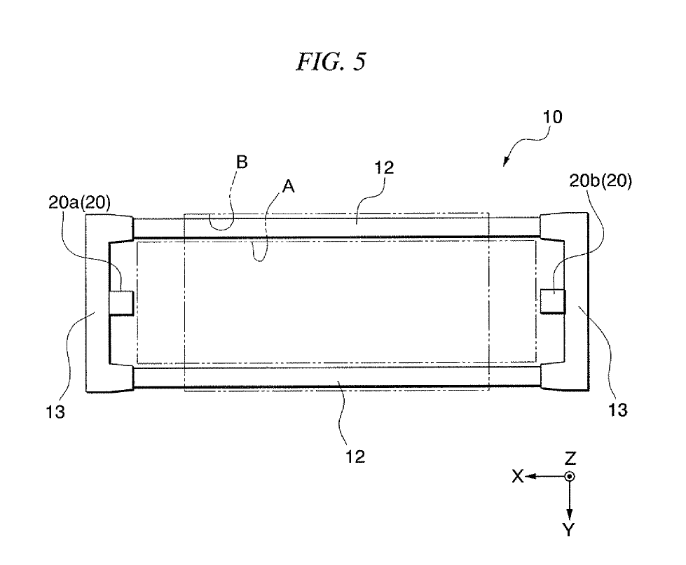

FIG. 5 is a plane view schematically showing the lower frame 10. As shown in the figure, the lower frame 10 comprises two main frames 12, extending in the X direction and arranged in parallel, and two side frames 13 which connect together the end portions of the two main frames, forming a closed lower frame.

The main frames 12 are arranged so as to be positioned farther apart than the width (Y-direction width) of the cage 40, described below, and closer together than the width (Y-direction width) of the goods X. Further, the side frames 13 are arranged so as to be positioned farther apart than the length (X-direction length) of the cage 40. Hence a region A into which the cage 40 can enter from above is formed by the main frames 12 and side frames 13.

The masts 20 are erected vertically on the lower frame 10, and comprise a mast 20a erected on one side frame 13a of the lower frame 10, and a mast 20b erected on the other side frame 13b of the lower frame.

The masts 20 protrude and extend to the lower side of the lower frame 10. That is, the masts 20 extend past the lower frame 10 toward the side of the surface on which the rails R1, R2 are laid (the floor surface of the cleanroom CL1).

The masts 20a and 20b are arranged in the X direction. That is, the masts 20a and 20b are erected at the same Y-direction position.

The masts 20 have a square-column shape, and are erected such that each side face is parallel to the X direction or to the Y direction. And as shown in FIG. 5, the masts 20 are erected protruding from the side frames 13 of the lower frame 10 on the side of the region A by fixing the masts 20 in a state in which side faces contact with side portions of the side frames 13.

The upper frame 30 connects the upper-end portion of the mast 20a with the upper-end portion of the mast 20b, and is arranged extending in the X direction.

A guide roller (not shown) is installed in substantially the center portion of the upper frame 30, in order to deter Y-direction tilting motion of the stacker crane C by enclosing the rail R3.

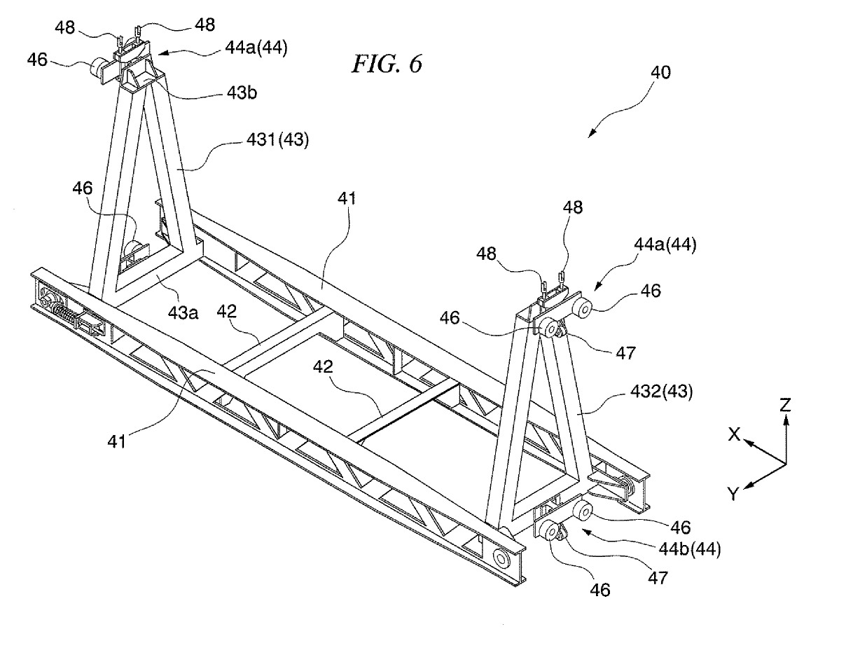

FIG. 6 is a perspective view of the cage 40. As shown in the figure, the cage 40 has two main frames 41 extending in the X direction. The main frames 41 are connected together by means of reinforcing members 42. Side frames 43 are connected to both end portions of the main frames 41.

The side frames 43 have substantially a triangular shape erected in the Z direction, the lower-edge portions of which connect the two main frames 41. The side frames 43 comprise a guide portion 44 protruding from the lower-edge portion and the vertex portion in the directions of the masts 20.

On the guide portions 44 are installed guide rollers 46 which enclose the masts 20, and small-size guide rollers 47. These guide rollers 46, 47 have as sliding surfaces the side faces of the masts 20. The side frames 43, and in addition the cage 40, can move vertically (in the Z direction) along the masts 20 by means of being guided by these guide rollers 46, 47.

Further, connection portions 48 which is connected to elevator wires 51 comprised by the driving device 50 described below, are installed on the guide portions 44 protruding from the vertex portions of the side frames 43.

Returning to FIG. 3 and FIG. 4, the driving device 50 comprises elevator wires 51, drum 52, motor 53, and decelerator 54.

One end of each elevator wire 51 is connected to the connection portion 48 of a guide portion 44 comprised by the side frames 43 of the cage 40, and the other end is wound around the drum 52. As the elevator wires 51, there exist an elevator wire 51a connected to the guide portion 44a of the side frame 431 positioned on the side of the mast 20a, and an elevator wire 51b connected to the guide portion 44a of the side frame 432 positioned on the side of the mast 20b; one end of both elevator wires 51a, 51b is wound around the drum 52.

Sheaves 55 to guide the elevator wires 51 are installed on the vertex portion of the mast 20a and on the vertex portion of the mast 20b. The sheave 55a installed on the vertex portion of the mast 20a is freely rotatable in the X-Z, plane. The sheaves 55 guides the elevator wire 51 to the guide portion 44a protruding from the side frame 431, as well as guiding the elevator wire 51b to the sheave 55b installed on the vertex portion of the mast 20b. The sheave 55b installed on the vertex portion of the mast 20b is freely rotatable in the X-Z plane, and guides the elevator wire 51b to the guide portion 44a protruding from the side frame 432.

The drum 52 is installed on the side frame 13a of the lower frame 10, and is capable of rotation about a rotation shaft oriented in the Y direction.

The motor 53 is connected to the drum 52 via the decelerator 54, and rotates the drum 52 via the decelerator 54. The motor 53 and decelerator 54 are each installed at both ends of the drum 52.

The control device 60 controls operation of the entire stacker crane C, and is installed on the side frame 13b of the lower frame 10. The control device 60 is electrically connected by a cable 61 to an external control device which controls the entire automated warehouse S.

In such a stacker crane C, as shown in FIG. 5, by controlling the motor 53 to adjust the amount of rotation of the drum 52, the winding amounts of the elevator wires 51 are changed. By this means the height of the side frames 43 of the cage 40 connected to the elevator wires 51 is adjusted. That is, the height of the cage 40 is controlled by driving of the driving device 50. And, by adjusting the travel position of the stacker crane C and the height of the cage 40, transfer of goods X is performed by the transfer device 100 mounted on the cage 40.

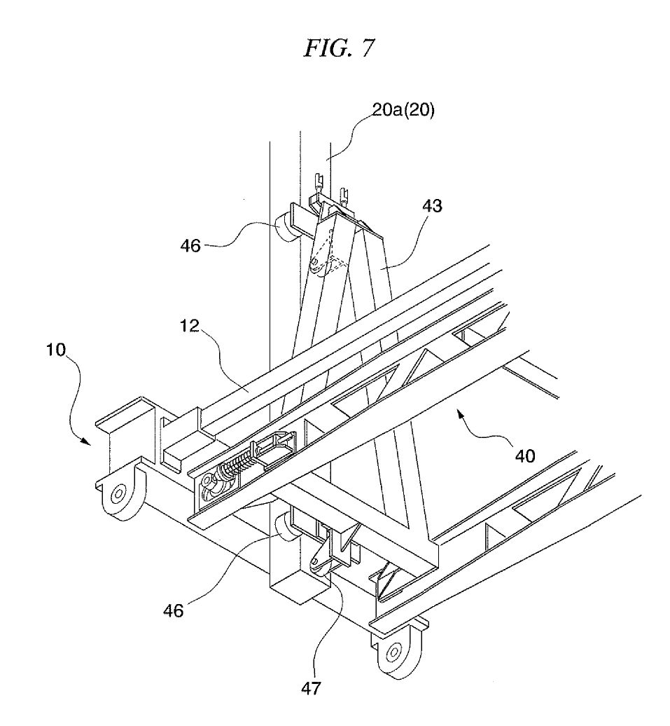

As shown in FIG. 5, in the stacker crane C of this embodiment, the lower frame 10 comprises main frames 12 positioned wider than the width of the cage 40 and side frames 13 positioned further apart than the length of the cage 40, so that a region A is formed into which the cage 40 can enter from above. Consequently, as shown in the perspective view of FIG. 7, the cage 40 which moves vertically between the masts 20 can move vertically without interference with the lower frame 10 in the range in which contact of the guide rollers 46, 47 with the masts 20 is possible.

That is, the lower frame 10 is installed avoiding the region of movement of the cage 40 in the range in which the guide rollers 46, 47 of the cage 40 can contact with the masts 20.

Hence by means of the stacker crane C of this embodiment, which is a stacker crane in which a cage moves vertically between masts 20, the occurrence of dead space due to interference of the cage and the lower frame can be prevented. Hence the cage 40 can be moved to the lowest level in the range in which contact between the guide rollers 46, 47 and the masts 20 is possible (see FIG. 7), and the space within the automated warehouse S can be effectively utilized, so that the efficiency of storage of goods X in the automated warehouse S can be improved.

Further, as shown in FIG. 5, in the stacker crane C of this embodiment, the interval between main frames 12 of the lower frame 10 is narrower than the width of goods X (region B).

In the automated warehouse S, goods X are transported by the stacker crane C, and so at least space sufficient for travel of the stacker crane C loaded with goods X is secured. Hence when the interval between main frames 12 of the lower frame 10 is narrower than the width of the goods X, as in the case of the stacker crane C of this embodiment, there is no need to broaden the travel region of the stacker crane C due to the main frames 12, and the occurrence of dead space due to the main frames 12 can be prevented.

Further, in the stacker crane C of this embodiment, the masts 20 extend from the lower frame 10 to the side of the surface on which the rails R1, R2 are laid (the floor of the cleanroom CL1).

Consequently, the cage 40 can be lowered to very close to the surface on which the rails R1, R2 are laid, and so more effective utilization of the space within the automated warehouse S is possible, so that the efficiency of storage of goods X in the automated warehouse S can be further improved.

In the above, a preferred embodiment of a stacker crane of this invention has been explained referring to the drawings; however, the invention is of course not limited to the above embodiment. In the above-described embodiment, the shapes, combinations and similar of the various component members are merely one example, and various modifications are possible based on design requirements and similar without deviating from the gist of the invention.

For example, in the above embodiment, a configuration was explained in which the lower frame 10 is the mast support frame of this invention. However, this invention is not limited to such a configuration, and for example the upper frame 30 may be configured like the lower frame comprising a pair of main frames and a pair of side frames, like the mast support frame of this invention as shown in FIG. 5. In this case, the upper frame 30 is installed so as not to interfere with the cage 40.

Further, in the above embodiment, a configuration was explained in which the guide rollers 47 installed on the guide portions 44b of the cage 40 protrude downward. However, the invention is not limited to such a configuration, and for example configurations may be employed in which there are no guide rollers, or in which the guide rollers 47 installed on the guide portions 44b protrude upwards. In such a case, the cage 40 can move still further downward, and so space within the automated warehouse S can be utilized still more effectively.

Further, in the above embodiment, a configuration was explained in which the goods for transport by the stacker crane C are cassettes in which are accommodated glass substrates; but the invention is not limited to such a configuration.

### INDUSTRIAL APPLICABILITY

By means of this invention, the mast support frame of this invention is installed avoiding the region of movement of the elevator portion in the range in which the elevator portion and masts can make contact, so that in the range in which the elevator portion and masts can make contact, there is no interference between the elevator portion and the mast support frame. Hence in a stacker crane in which the elevator portion moves vertically between masts, the occurrence of dead space due to interference between the elevator portion and the lower frame can be prevented.

1. A stacker crane, which transports goods between storage shelves, comprising:
the storage shelves, arranged on a plurality of levels;
an elevator portion, traveling on tracks provided along the storage shelves, and which accommodates goods;
a set of masts, which move vertically while in contact with the elevator portion; and,
a mast support frame, installed avoiding the region of movement of said elevator portion in the range in which said elevator portion and said masts can make contact.

2. The stacker crane according to claim 1, wherein said mast support frame comprises a pair of main frames arranged along said tracks and separated by a distance greater than the width of said elevator portion, and side frames which connected the end portions of the main frames to each other.

3. The stacker crane according to claim 2, wherein the interval between said main frames is smaller than the width of said goods.

4. The stacker crane according to claim 1 wherein said masts extend from said mast support frame toward the surface on which said tracks are laid.
